(19) United States
(12) Patent Application Publication
(10) Pub. No.: US 2018/0114222 A1
(43) Pub. Date: Apr. 26, 2018

(54) Future Generation Automated Teller Machine (ATM)

(71) Applicant: Bank of America Corporation, Charlotte, NC (US)

(72) Inventors: Ryan Furey, Charlotte, NC (US); Charles R. Liu, Sunnyvale, CA (US); Matthew E. Williams, Little Elm, TX (US); Elizabeth A. Price, Newport, TN (US); Richard Barron, Glen Rock, NJ (US)

(21) Appl. No.: 15/787,844

(22) Filed: Oct. 19, 2017

Related U.S. Application Data
(60) Provisional application No. 62/411,175, filed on Oct. 21, 2016.

(51) Int. Cl. G06Q 20/40; G06Q 20/10

(52) U.S. Cl. CPC G06Q 20/401; G06Q 20/1085

(57) ABSTRACT

Aspects of the disclosure relate to interaction among an entity, an entity's mobile device, one or more Automated Teller Machines (ATM's), an associated beacon generator, and a support computing system. With some embodiments, the beacon generator generates a beacon signal to the mobile device. The mobile device extracts beacon information such as an identification of the beacon generator and/or associated ATM and conveys this information to the support computing system via a second wireless channel. The support computing system subsequently instructs the ATM to transition to an appropriate display container as the entity approaches the ATM. The ATM may further transition to different display containers based on interactions with the entity and/or support computing system.

This patent application claims priority to U.S. provisional patent application Ser. No. 62/411,175 entitled “Future Generation Automated Teller Machine (ATM)” filed on Oct. 21, 2016, which is hereby incorporated by reference in its entirety.

### TECHNICAL FIELD

Aspects of the disclosure relate to interactions between computing devices of a multicomputer system. Based on the detected events and event data, a client computing device may be directed by a computing platform to perform an appropriate action.

### BACKGROUND

It is important that the capabilities of computer systems incorporating Automated Teller Machines (ATM's) be expanded to, as well as be enhanced, to address deficiencies of traditional approaches in order to better satisfy the needs of users.

### SUMMARY

The following presents a simplified summary in order to provide a basic understanding of some aspects of the invention. The summary is not an extensive overview of the invention. It is neither intended to identify key or critical elements of the invention nor to delineate the scope of the invention. The following summary merely presents some concepts of the invention in a simplified form as a prelude to the description below.

According to one or more aspects, an automated teller machine (ATM) comprises a computing device with a large digital display that may have multiple uses. The computing device can be used to display non-transaction information and then with the touch of a button by a user (an entity or customer) can transform the computing device to support ATM functionalities. The computing device includes components to start and exit ATM sessions.

With another aspect, an ATM system may comprise one or more ATM's, a beacon server, and a beacon generator. A mobile device (wireless device) of a user (entity) receives a beacon signal broadcast by the beacon generator, extracts beacon information from the signal, and sends the beacon information along with user information to the beacon server. Subsequently, the beacon server instructs a selected ATM in the ATM system to transition to an appropriate display container so that the selected ATM can handle the approaching user.

With another aspect, an ATM displays a first container during an unauthenticated session, where the first display container comprises non-transaction content. The ATM detects whether an activation input has been entered, where the activation input is indicative that a user (entity) requests transformation of the ATM to an ATM transaction. In response to the detecting, the ATM transitions to a second display container during an authenticated session, where the second display container comprises a first transaction display component and a first non-transaction display component. In response to input information during the authenticated session, the ATM transitions to a third display container, where the third display container comprises a second transaction display component and a second non-transaction display component and where the second non-transaction display component is targeted to the user.

With another aspect, ATM system supports a responsive action when an ATM displays non-transactional content and interactive information is received through an input device (for example, touchscreen) of the ATM.

With another aspect, a beacon server of an ATM system sends direction information to a mobile device to guide the user to a selected ATM within the ATM system. The direction information may comprise map content and may be based on the distance between the mobile device and the selected ATM.

With another aspect, a beacon server of an ATM system may instruct an alternative ATM to serve an entity (user) if the initially selected ATM is not available.

With another aspect, a mobile device executes a mobile app when in communication with a beacon generator of an ATM system. The mobile app may send extracted beacon information and user information to a beacon server and may receive direction information to the selected ATM in the ATM system.

Aspects of the invention may be provided in a computer-readable medium having computer-executable instructions to perform one or more of the process steps described herein. These and other aspects of the invention are discussed in greater detail throughout this disclosure, including the accompanying drawings.

### BRIEF DESCRIPTION OF THE DRAWINGS

The present disclosure is illustrated by way of example and not limited in the accompanying figures in which like reference numerals indicate similar elements.

FIG. 1 shows an Automated Teller Machine (ATM) in accordance with one or more illustrative aspects described herein.

FIGS. 2-9 show different display containers that an ATM may display in accordance with one or more illustrative aspects described herein.

FIGS. 10-12 show capabilities and benefits of an ATM in accordance with one or more illustrative aspects described herein.

FIGS. 13-14 show attributes of an ATM in accordance with one or more illustrative aspects described herein.

FIG. 15 shows a system that includes an ATM in accordance with one or more illustrative aspects described herein.

FIG. 16 shows a flowchart of a client engaging with an ATM in accordance with one or more illustrative aspects described herein.

FIG. 17 shows capabilities of an ATM in accordance with one or more illustrative aspects described herein.

FIG. 18 shows actions that are supported based on a client's desired level of engagement at an ATM in accordance with one or more illustrative aspects described herein.

FIG. 19 shows risk mitigation at an ATM in accordance with one or more illustrative aspects described herein.

FIG. 20 shows an ATM system with a beacon generator in accordance with one or more illustrative aspects described herein.

FIG. 21 shows an ATM system with a beacon generator spanning a plurality of ATM's in accordance with one or more illustrative aspects described herein.

FIG. 22 shows an illustrative event sequence for multicomputer processing with the computing environment shown in FIG. 20 in accordance with one or more example embodiments.

FIG. 23 shows an illustrative event sequence for multicomputer processing with the computing environment shown in FIG. 20 in accordance with one or more example embodiments.

FIG. 24 shows an illustrative event sequence for multicomputer processing with the computing environment shown in FIG. 21 in accordance with one or more example embodiments.

FIGS. 25A-25B show an illustrative event sequence for multicomputer processing with the computing environment shown in FIG. 21 in accordance with one or more example embodiments.

FIG. 26 shows a beacon generator in accordance with one or more illustrative aspects described herein.

### DETAILED DESCRIPTION

In the following description of various illustrative embodiments, reference is made to the accompanying drawings, which form a part hereof, and in which is shown, by way of illustration, various embodiments in which the claimed subject matter may be practiced. It is to be understood that other embodiments may be utilized and structural and functional modifications may be made without departing from the scope of the present claimed subject matter.

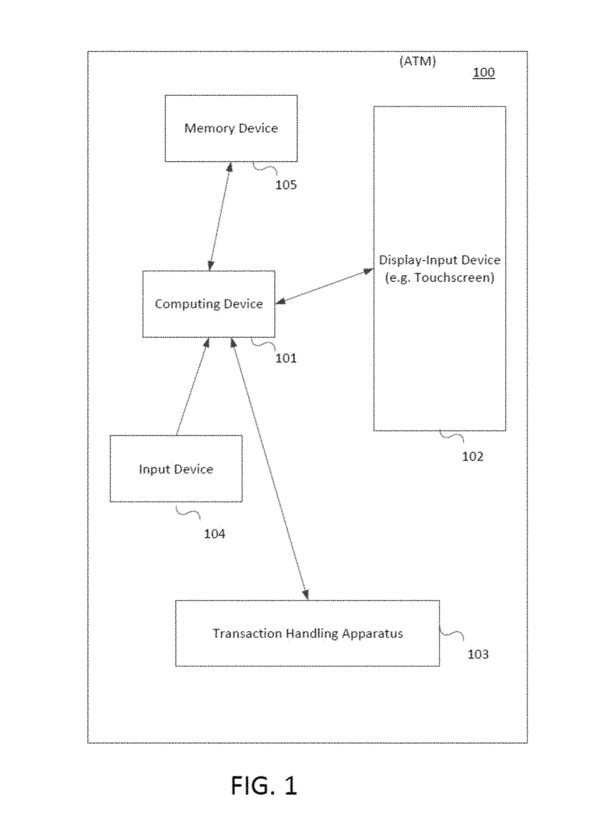

FIG. 1 illustrates an example of a suitable computing system environment for Automated Teller Machine (ATM) 100 that may be used according to one or more illustrative embodiments for implementing any of the computing devices in FIG. 1 to perform processes. ATM 100 is only one example of a suitable computing environment and is not intended to suggest any limitation as to the scope of use or functionality of the invention. ATM 100 should not be interpreted as having any dependency or requirement relating to any one or combination of components shown in the illustrative computing system environment.

ATM 100 may include a computing device 101 wherein the processes discussed herein may be implemented. The computing device 101 may have a processor for controlling overall operation of the computing device 101 and its associated components, including memory device 105 (for example, RAM and ROM), display/input device 102, input device 104, and transaction handling apparatus 103.

Computing device 101 typically includes a variety of computer readable media. Computer readable media may be any available media that may be accessed by computing device 101 and include both volatile and nonvolatile media, removable and non-removable media. By way of example, and not limitation, computer readable media may comprise a combination of computer storage media and communication media.

Computer storage media include volatile and nonvolatile, removable and non-removable media implemented in any method or technology for storage of information such as computer readable ins tractions, data structures, program modules or other data. Computer storage media include, but is not limited to, random access memory (RAM), read only memory (ROM), electronically erasable programmable read only memory (EEPROM), flash memory or other memory technology, CD-ROM, digital versatile disks (DVD) or other optical disk storage, magnetic cassettes, magnetic tape, magnetic disk storage or other magnetic storage devices, or any other medium that can be used to store the desired information and that can be accessed by computing device 101.

Although not shown, memory device 105 may include one or more are applications representing the application data stored in memory device 105 while computing device 101 is on and corresponding software applications (for example, software tasks), are running on the computing device 101.

Computer-executable instructions may be stored within memory device 105 and/or storage to provide instructions to a processor for enabling computing device 101 to perform various functions. For example, memory device 105 may store computer-executable used by the computing device 101, such as an operating system, application programs, and an associated database. Alternatively, some or all of the computer executable instructions for computing device 101 may be embodied in hardware or firmware (not shown).

Embodiments of the invention may include forms of computer-readable media. Computer-readable media include any available media that can be accessed by a computing device 101. Computer-readable media may comprise storage media and communication media. Storage media include volatile and nonvolatile, removable and non-removable media implemented in any method or technology for storage of information such as computer-readable instructions, object code, data structures, program modules, or other data. Communication media include any information delivery media and typically embody data in a modulated data signal such as a carrier wave or other transport mechanism.

Memory device 105 include one or more program modules having instructions that when executed by computing device 101 cause ATM 100 to perform one or more functions described herein.

Although not required, various aspects described herein may be embodied as a method, a data processing system, or as a computer-readable medium storing computer-executable instructions. For example, a computer-readable medium storing instructions to cause a processor to perform steps (blocks) of a method in accordance with aspects of the invention is contemplated. For example, aspects of the method steps disclosed herein may be executed on a processor on computing device 101. Such a processor may execute computer-executable instructions stored on a computer-readable medium.

Referring to FIG. 1, ATM 100 includes display-input device 102 that enables the user to input information into ATM 100 and displays information to the user while the user is making an ATM transaction. In addition, as will be discussed. ATM 100 may display non-transaction information (for example, non-targeted and targeted ads) to the user before and during an ATM transaction. Display-input device 102 may assume different forms such as a touchscreen. For example, with some embodiments, device 102 may support a 32 or 40 inch display.

ATM 100 includes also input device 104 so that a user can enter security information (for example, a PIN) that is not typically visible to others to provide privacy for the user.

ATM 100 typically includes transaction handling apparatus 103 that accepts currency and the like and dispenses cash during a transaction.

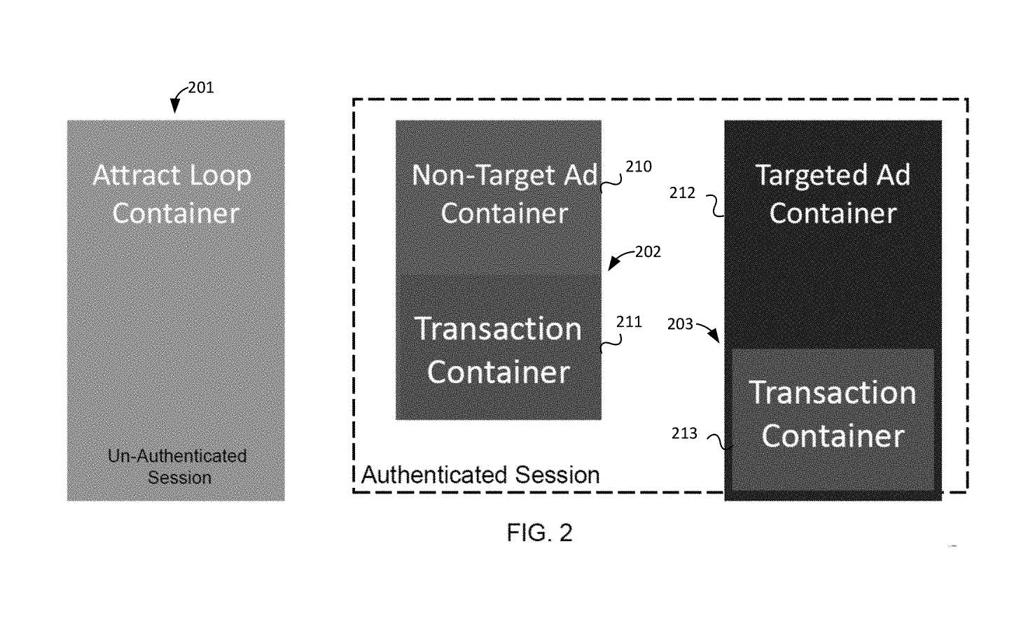

FIGS. 2-9 show different display containers that an ATM may display in accordance with one or more illustrative aspects described herein.

Referring to FIG. 2, ATM 100 supports three display states for displaying display containers 201, 202, and 203 on display/input device 102. During the first display state, ATM 100 displays first display container 201 (attract loop container) during an un-authenticated session. First display container 201 may include only non-transaction content as will be discussed. During the second display state, ATM 100 displays second display container 202 (non-target ad container) that comprises a first non-transaction component 210 (non-target ad content) and a first transaction component 211 (transaction container). During the third display state, ATM displays third display container 203 (targeted ad container) that comprises second non-transaction component 212 (targeted non-transaction content) and second transaction component 213 (transaction container).

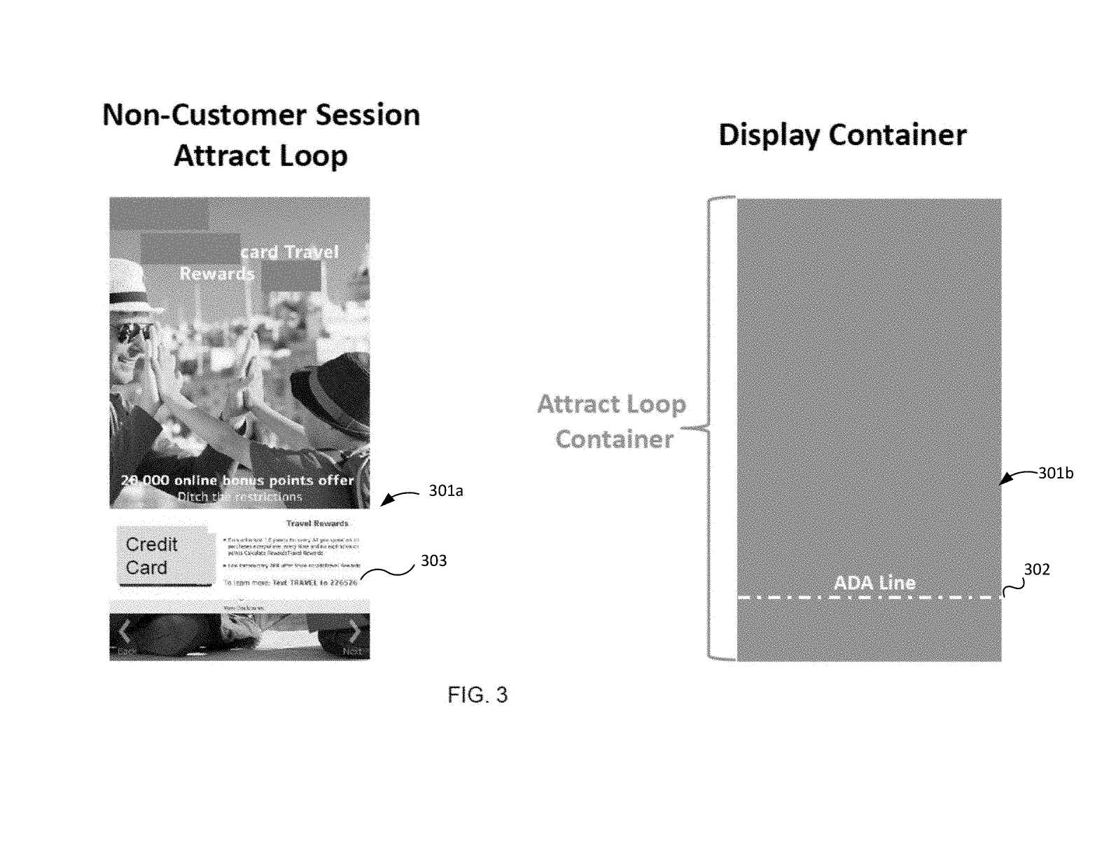

Referring to FIG. 3, ATM 100 displays first display container 301a,301b (attract loop container) on display/input device 102 for users (customers or entities) physically passing by ATM 100. Attract loop container 301a,301b may display non-transaction information on all digital screens, for example where non-transaction information is displayed on a screen cycle through a set of non-transaction information. Moreover, characteristics of the non-transaction information cycling may be altered through an input mechanism. ATM 100 may display one of different types of non-transaction information that are not targeted to a specific user. With some embodiments, ATM 100 displays the same non-transaction information across all screens. With some embodiments, ATM 100 may allow a user to scroll through displayed non-transaction information providing access to all non-transaction information in the attract loop.

ADA line 302, as depicted in first container 301b in FIG. 3, is in accordance with requirements (for example height and reach compliance) set forth in the Americans with Disabilities Act (ADA).

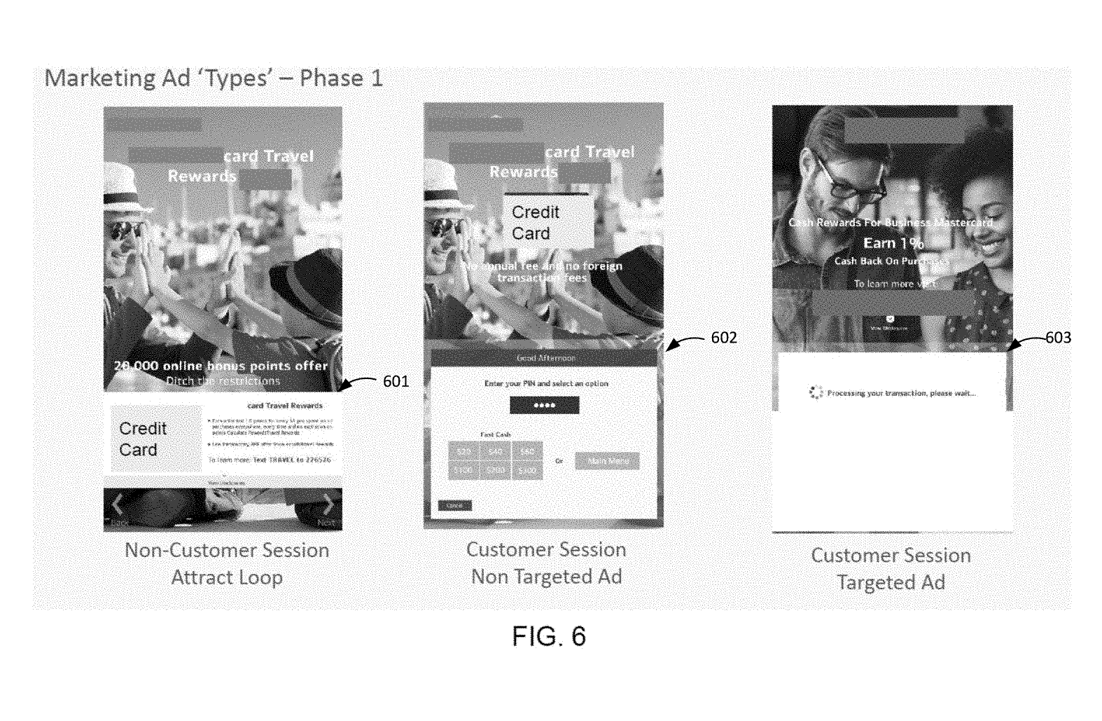

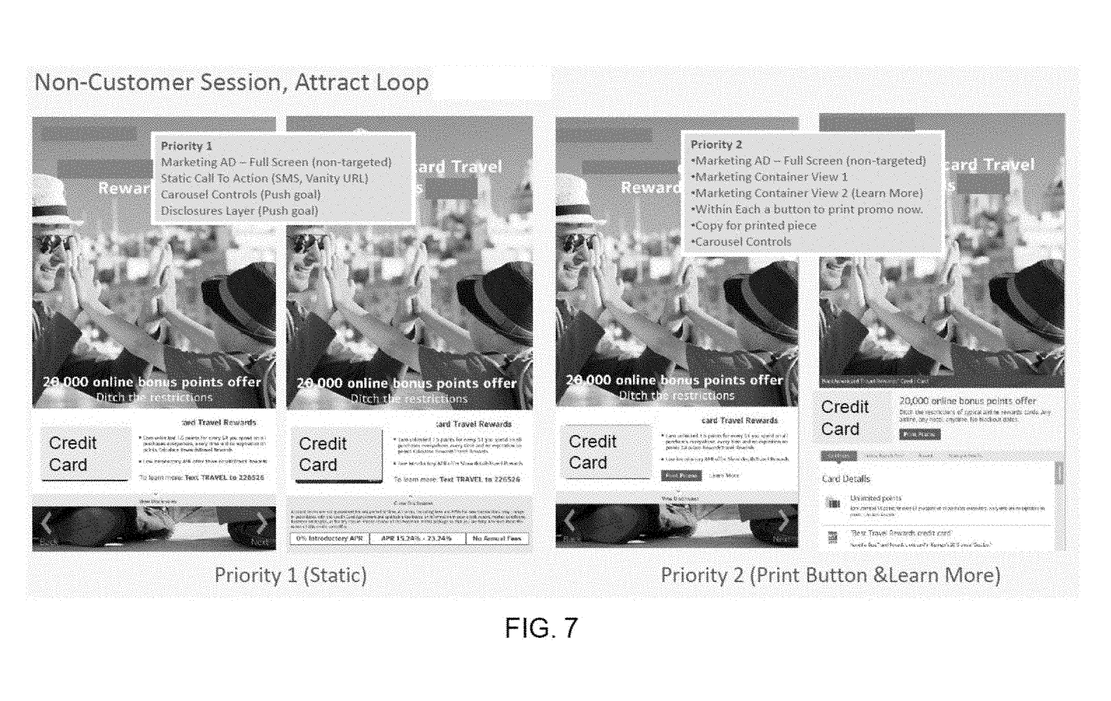

FIG. 6 shows examples of display containers 201, 202, and 203 corresponding to containers 601, 602, and 603, respectively. Additional exemplary embodiments of first display container 201 are shown in FIG. 7.

With some embodiments, ATM 100 transitions from a first display state to a second display state when a user presses a designated button supported by an input device of ATM 100. When in the second display state, ATM displays a second display container.

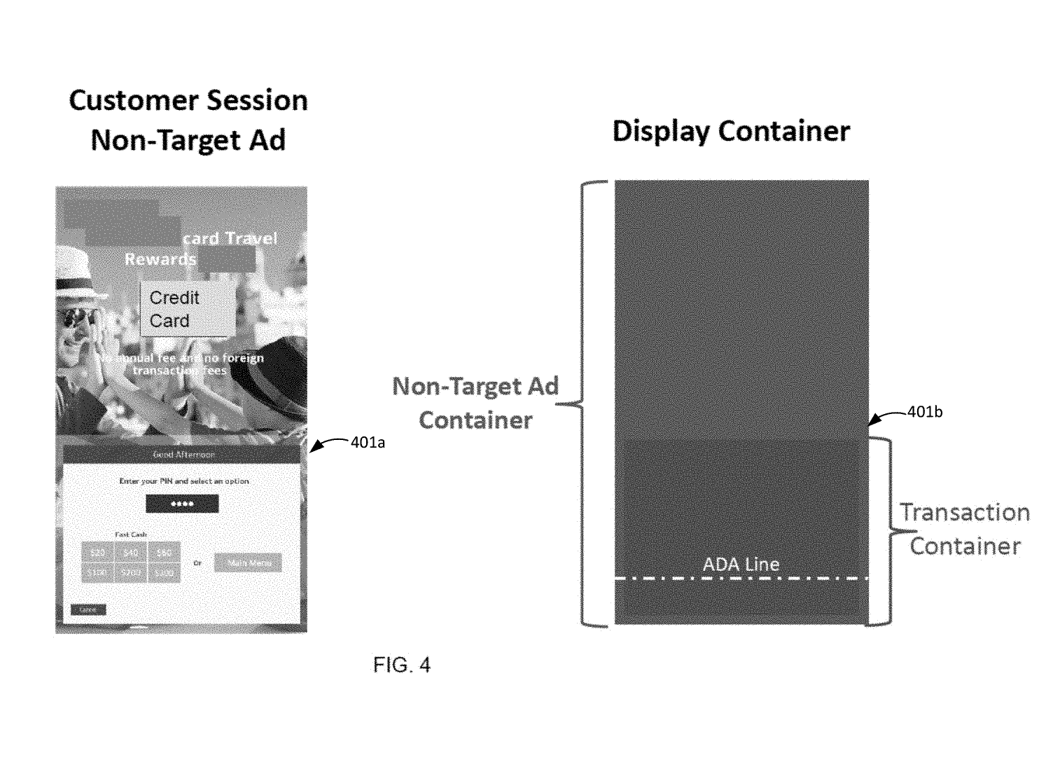

Referring to FIG. 4, ATM 100 displays second display container 401a,401b that includes the first non-transaction component 210 (non-target ad content) and the first transaction component 211. ATM 100 may allow the user to scroll through non-transaction information, providing access to all non-transaction information in the attract loop.

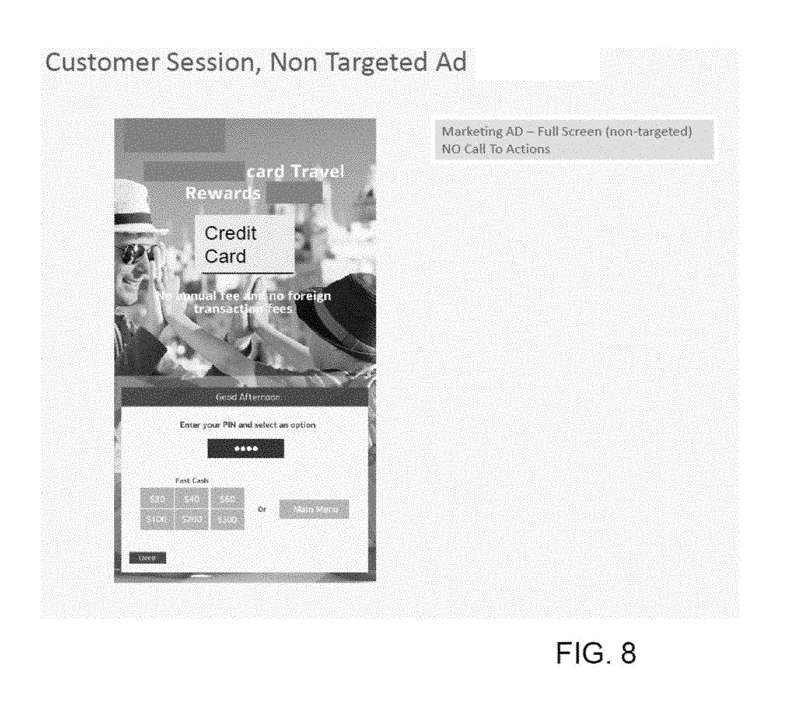

An exemplary example of second display container 401b are shown in FIG. 8.

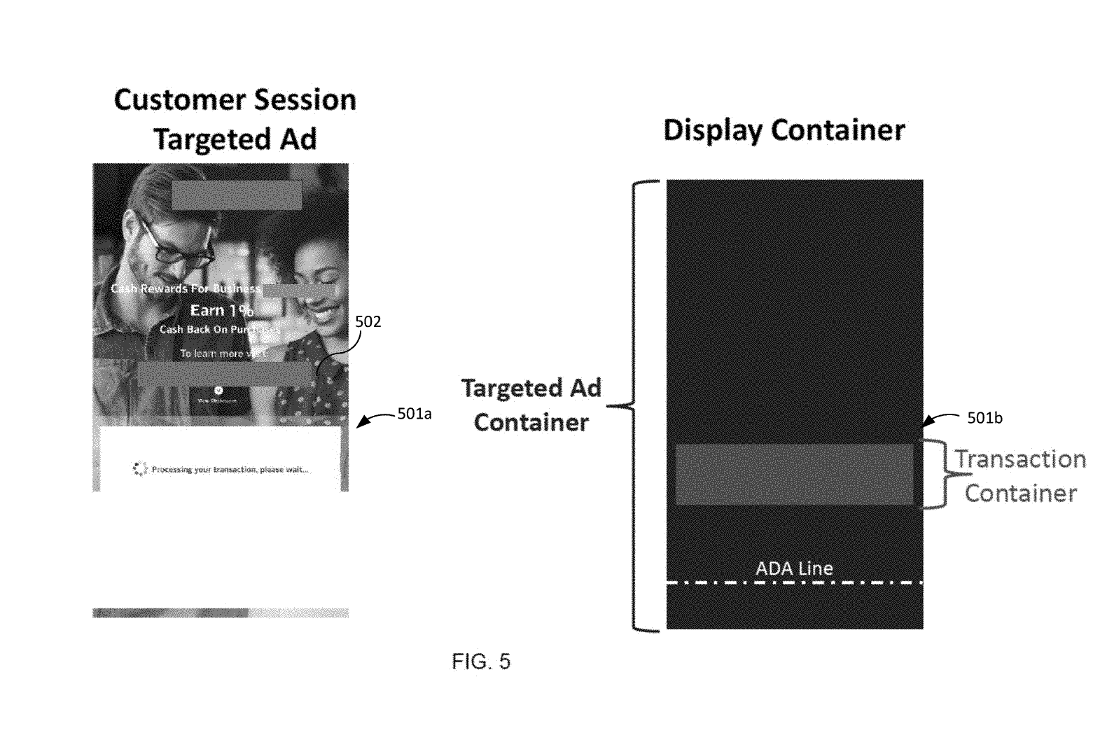

Referring to FIG. 5, ATM 100 displays the third display container 501a,501b that comprises the second non-transaction component 212 and the second transaction component 213. With some embodiments, targeted offers appear as being displayed in the second transaction component (Transaction Container).

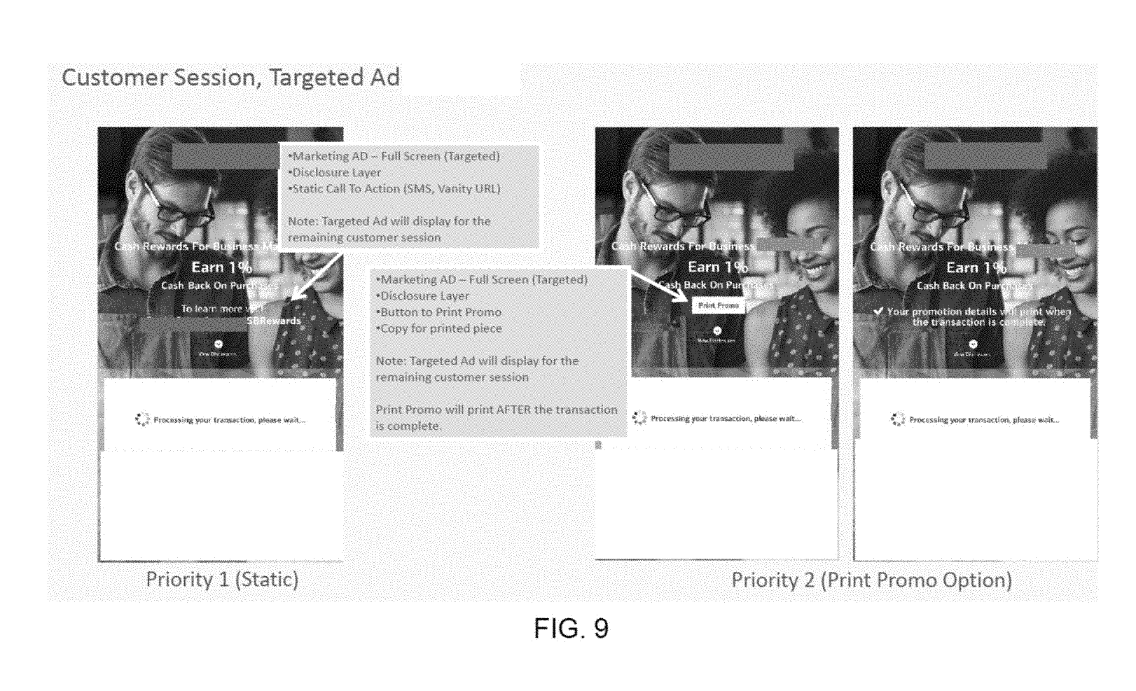

Exemplary examples of third display container 501b are shown in FIG. 9.

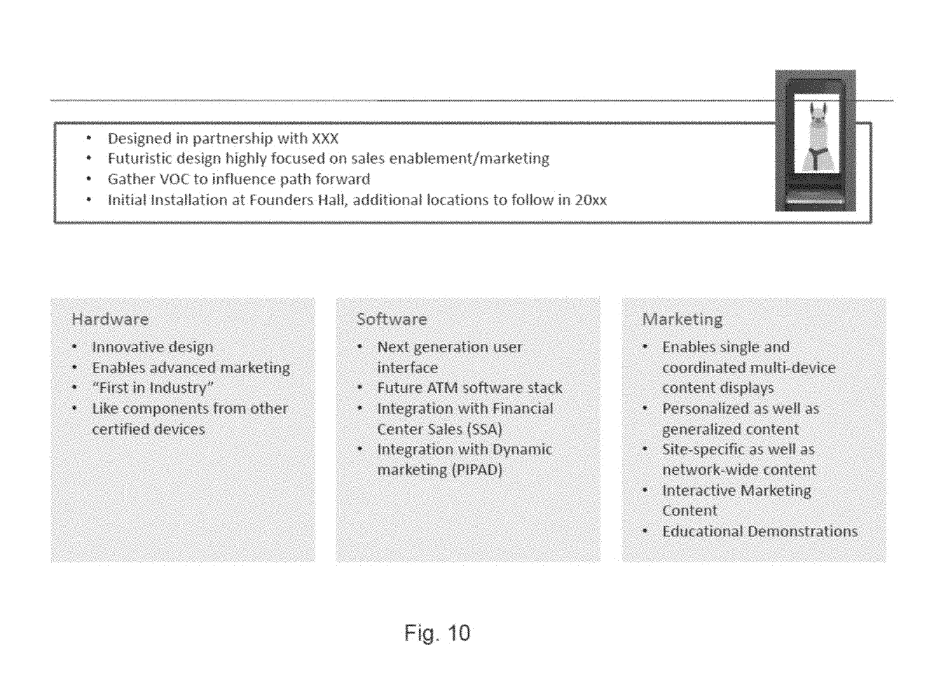

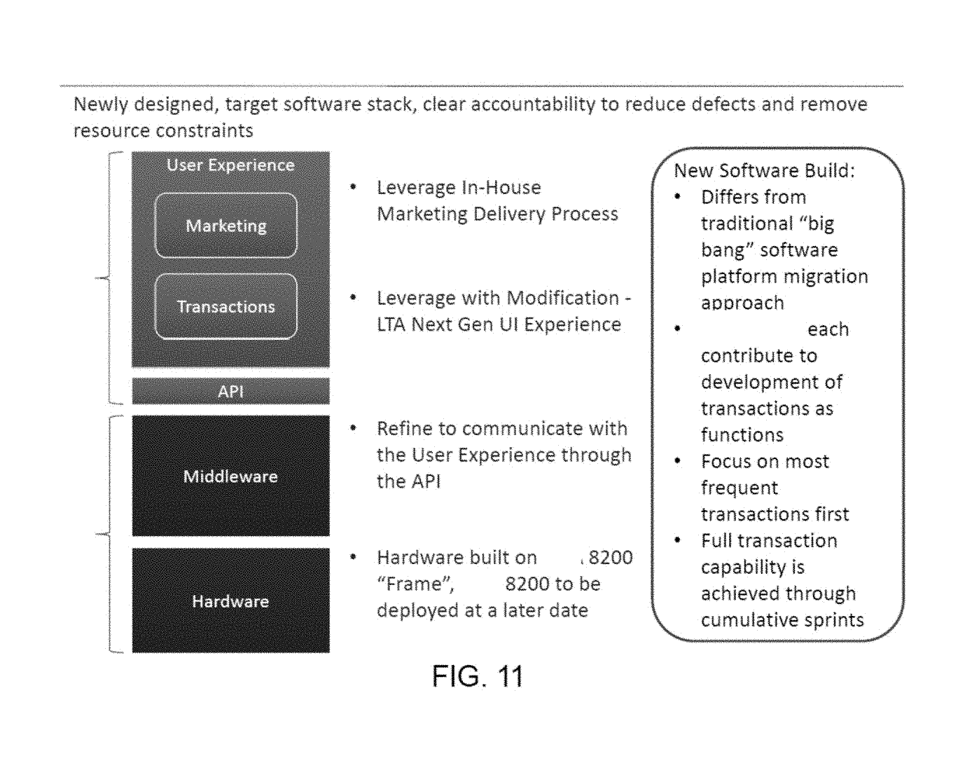

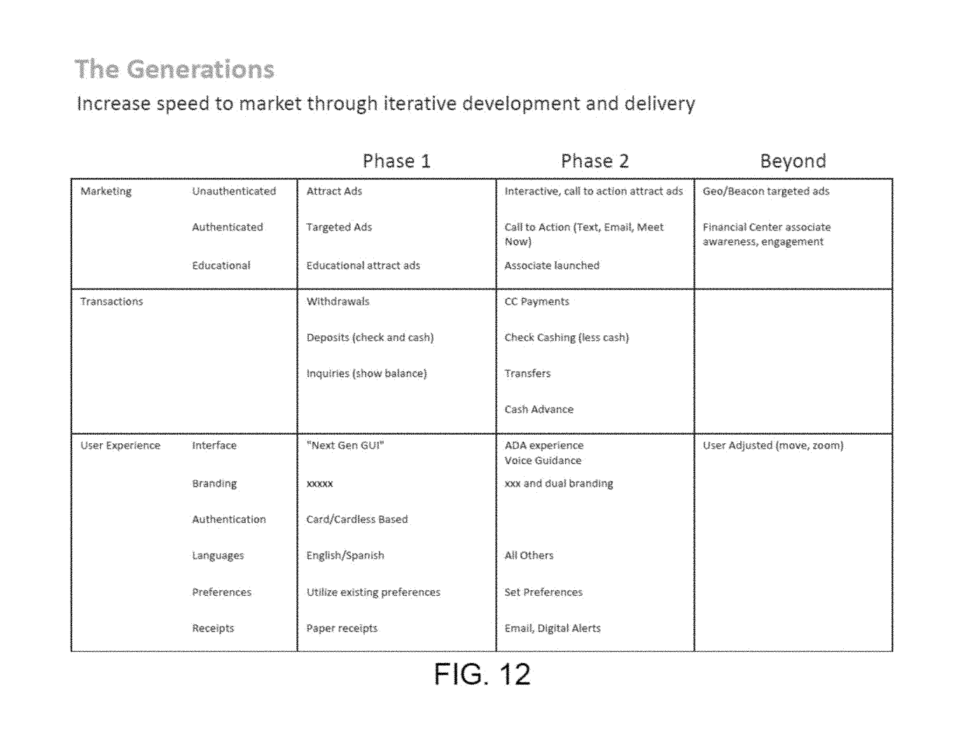

FIGS. 10-12 show capabilities and benefits of an ATM in accordance with one or more illustrative aspects described herein.

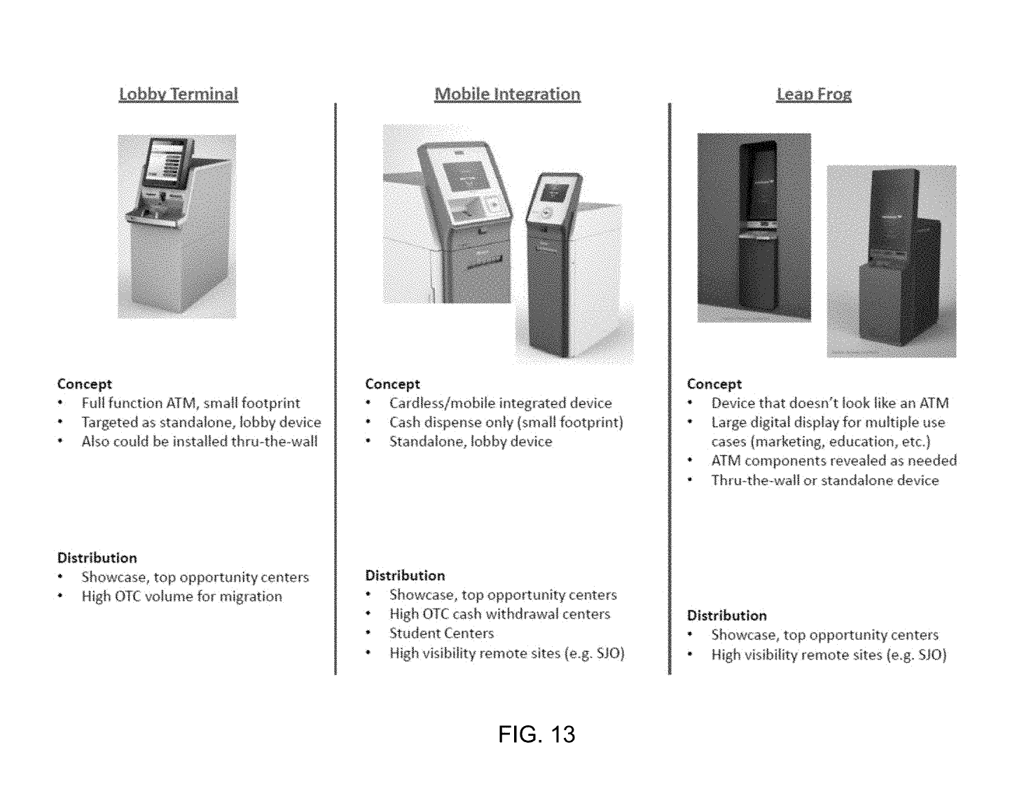

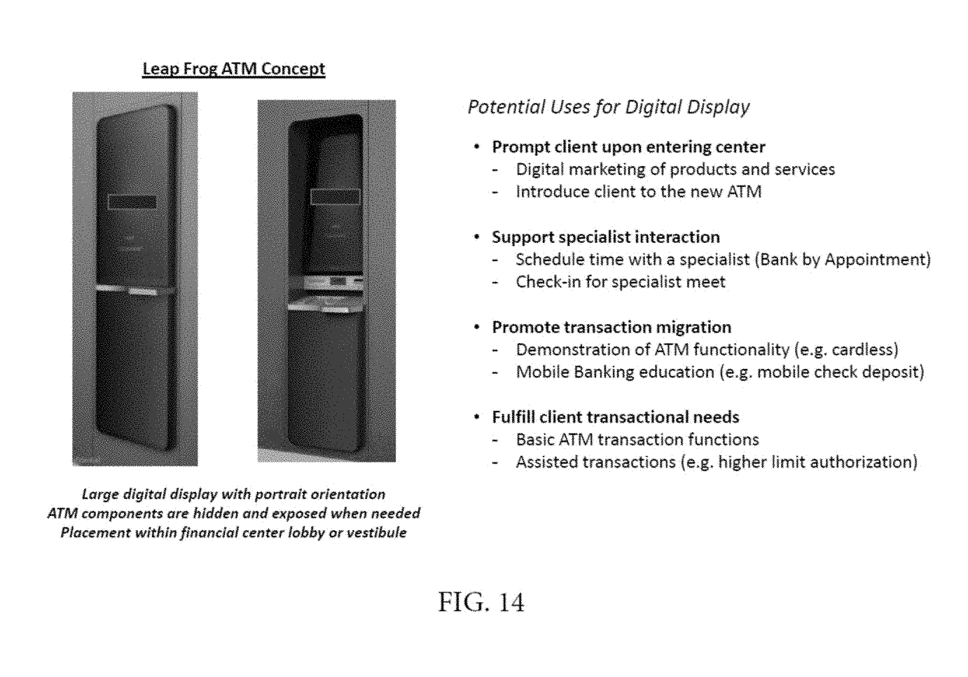

FIGS. 13-14 show attributes of an ATM in accordance with one or more illustrative aspects described herein.

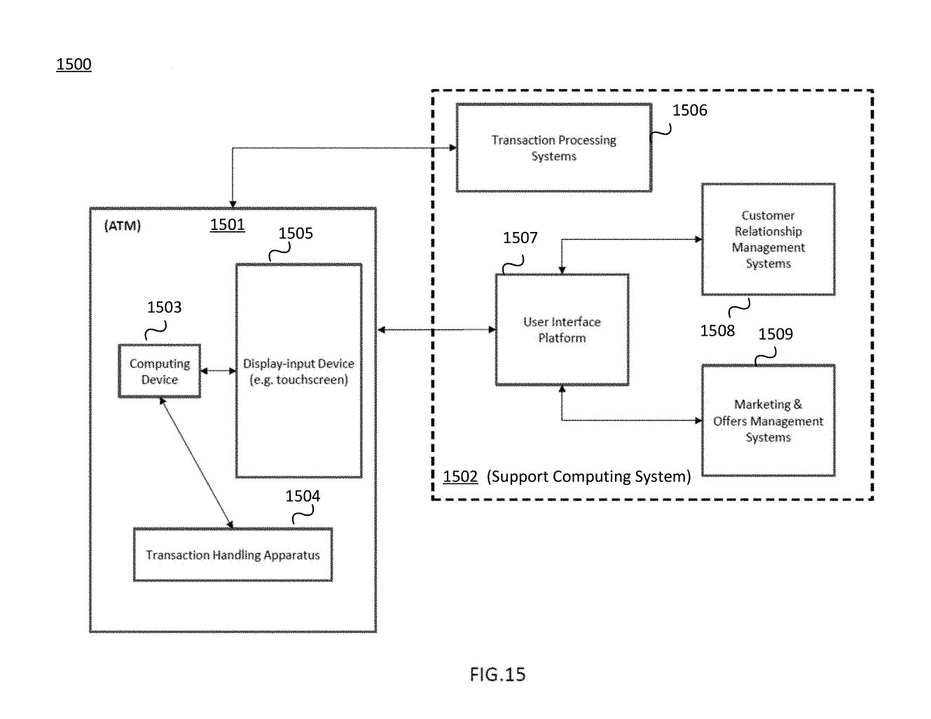

FIG. 15 shows computer system 1500 that includes ATM 1501 in accordance with one or more illustrative aspects described herein. ATM 1501 interacts with user interface platform 1507 of host system 1502 (support computing system) to support different display containers as shown in FIGS. 2-9.

ATM 1501 comprises computing device 1503, touchscreen 1505, and transaction handling apparatus 1504. Support computing system 1502 comprises transaction processing system 1506, user interface platform 1507, user relationship management system 1508, and marketing and offers management system 1509.

Transaction handling apparatus 1504 enables ATM 1501 to accept and dispense currency from/to user during a transaction with the user through interaction of the user via touchscreen 1504. Support computing system 1502 supports the transaction with transaction processing system 1506 interacting with ATM 1501.

Computing device 1503 displays display containers 201, 202, and 203 (as shown in FIG. 2) on touchscreen 1505 based on content and or commands provided by user interface platform 1507, in conjunction with user relationship management system 1508 and marketing and offers management system 1509.

With some embodiments, ATM 1501 includes content provided by transaction processing system 1506 and/or user interface platform 1507 within display containers 201, 202, and 203. For example, transaction components 211 and 213 may include content from transaction processing system 1506 and non-transaction components 210 and 212 may include content from user interface platform 1507. With some embodiments, ATM 1501 may also pre-store content, and may display the content, within display containers 201, 202, and/or 203 based on commands from support computing system 1502.

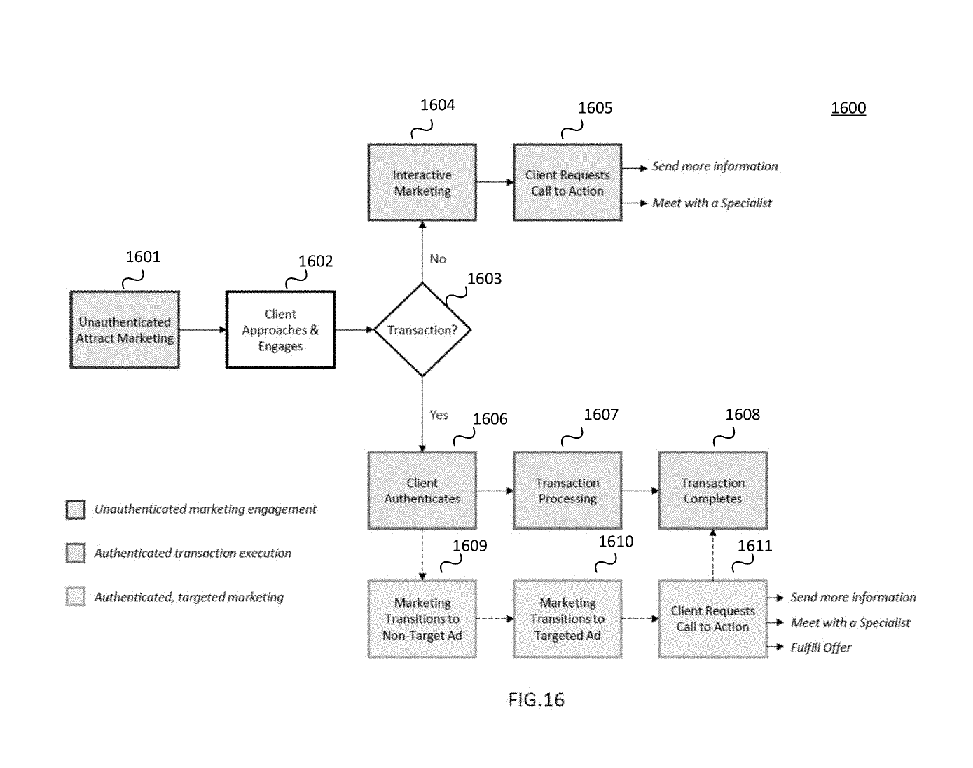

FIG. 16 shows flowchart 1600 of a user (client) engaging with an ATM in accordance with one or more illustrative aspects described herein. The process may be performed by ATM 100 or by ATM 1501 in conjunction with user interface platform 1507 as shown in FIG. 15.

At block 1601, ATM 100 displays first display container 201 (as shown in FIG. 2), which includes non-transaction content. If a user engages with ATM 100 (for example, by pressing a designated button or a portion of touchscreen 1505) at block 1602, ATM 100 displays second display container 202 that comprises first non-transaction component 210 and first transaction component 211.

If the user desires to proceed with a transaction at block 1603, the user enters his/her PIN at the appropriate portion of touchscreen 1505, for example as shown as second display container 401a. in FIG. 4. If not the user proceeds with interacting with the non-transaction content at blocks 1604 and 1605. For example, a user may select for more information at touchscreen portion 303 as shown in FIG. 3.

While the user is entering authentication information (for example, the user's PIN) at block 1606, ATM 100 transitions and display non-transaction component 210 at block 1609.

If the user desires to proceed with a transaction by entering his/her PIN and transaction selection, ATM 100 displays third display container 203, for example container 501a as shown in FIG. 5, while the transaction is processing at block 1607. As system 1500 is processing the transaction (for example, as shown in FIG. 5), ATM 100 displays second non-transaction component 212 (targeted ad content) at block 1610.

The user may enter input information indicative that the user wishes to interact with system 1500 about the displayed non-transaction component 212, for example by selection touchscreen portion 502 as shown in FIG. 5. If so, the system 1500 proceeds with executing block 1611 (as will be discussed in further detail) when the transaction completes at block 1608.

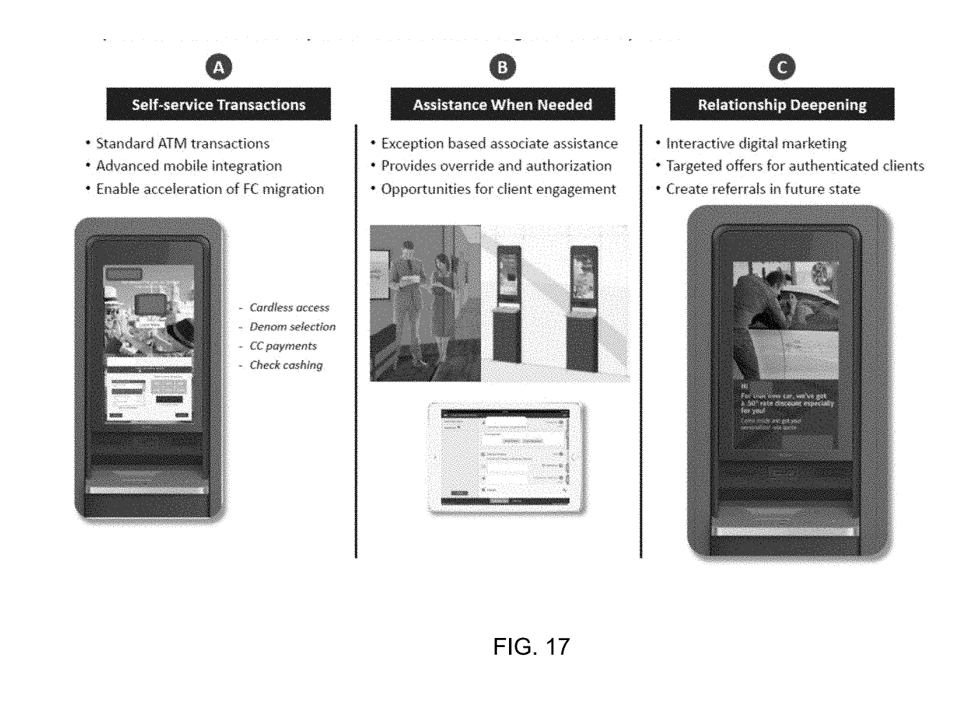

FIG. 17 shows capabilities of ATM 1501 in accordance with one or more illustrative aspects described herein.

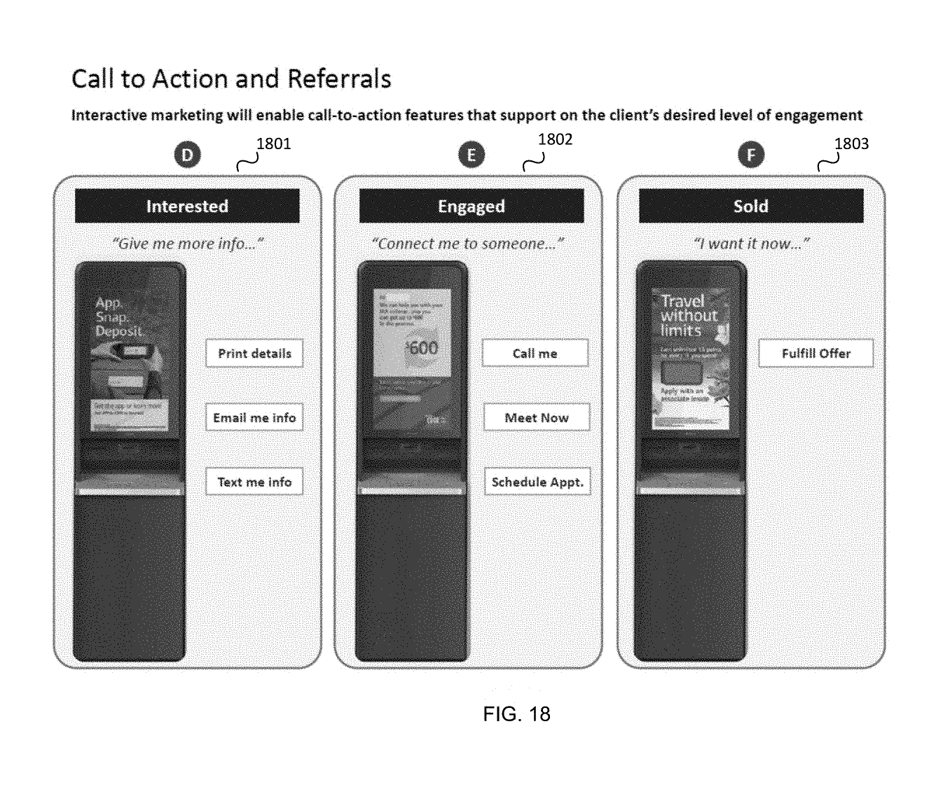

FIG. 18 shows actions 1801-1803 that are supported based on a client's desired level of engagement, at ATM 1501 in accordance with one or more illustrative aspects described herein.

With some embodiments, a user provide an input indicator (for example, indicator 502 as shown in FIG. 5) that is indicative that the user desires further action to non-transaction component 212 in accordance with block 1611 as shown in FIG. 16. Actions 1801, 1802, and 1803 correspond to varying degrees of engagement by the user, varying from obtaining more information, meeting with a specialist to fulfillment of an order.

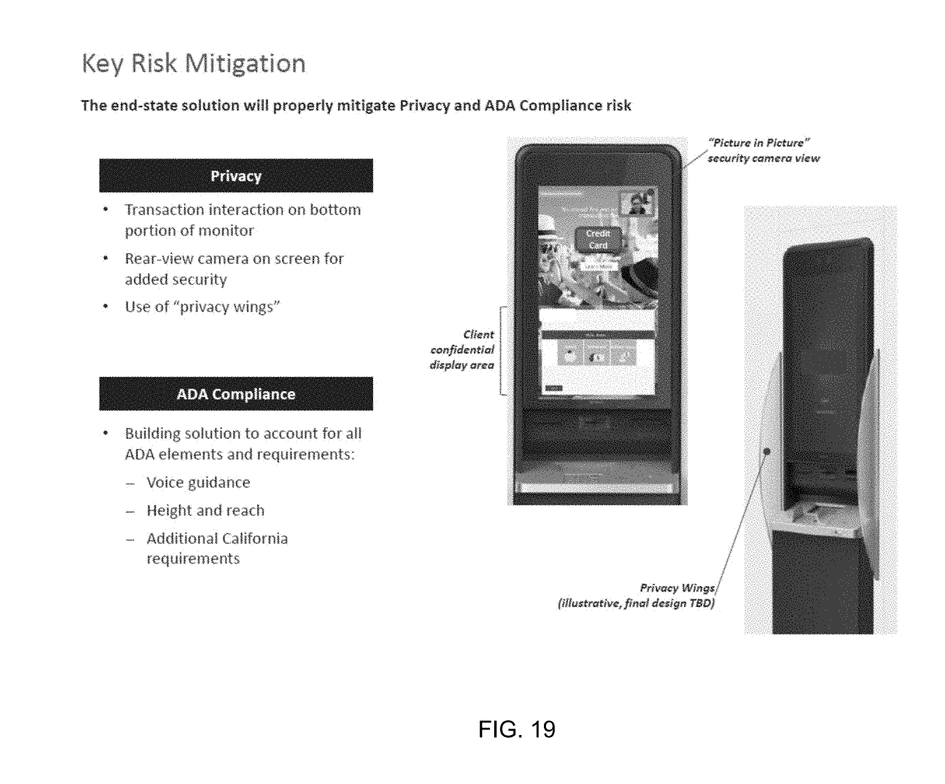

FIG. 19 shows risk mitigation at ATM 1501 in accordance with one or more illustrative aspects described herein. ATM 1501 may provide privacy and/or ADA compliance for a user. For example, ATM 1501 may be equipped with a rear-view camera so that a user can view what is behind the user via “picture in picture” video content.

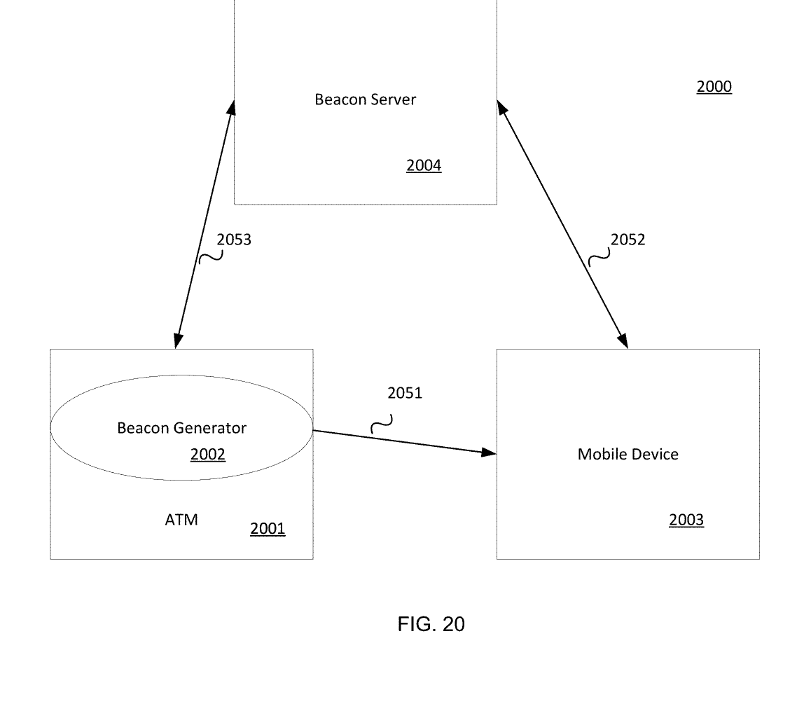

FIG. 20 shows ATM system 2000 with beacon generator 2002 in accordance with one or more illustrative aspects described herein.

ATM system 2000 is configured such that beacon generator 2002 is associated with ATM 2001, where beacon generator 2002 is located at or at close proximity to ATM 2001. Beacon generator 2002 transmits beacon information over a wireless communication channel 2051 that may be received by wireless device 2003 via a mobile app when wireless device 2003 is within the range of beacon generator 2002 and as a user is approaching ATM 2001. For example, beacon generator 2002 may support a communication protocol such as BLUETOOTH® having a class with a desired range. (BLUETOOTH supports different classes including 1, 2, 3, 4 with typical ranges of 100 meters, 10 meters, 1 meter, and 0.5 meters, respectively.)

With some embodiments, beacon information may include three main pieces of information that may be extracted by the mobile app. A 16-byte UUID may provide unique information across all beacons from any other deployers. A 2-byte Major value can be utilized to identify the location of ATM 2001, and a 2-byte Minor value can be used to identify the actual ATM 2001 itself.

After mobile device (wireless device) 2003 extracts beacon information from wireless communication channel 2051, mobile device 2003 communicates with beacon server 2004 over wireless communication channel 2052 via the mobile app. With some embodiments, wireless communication channel 2052 is established to a website supporting ATM system 2000 via wireless service provided by a wireless service provider.

In response to communication between mobile device 2003 and beacon server 2004, beacons server 2004 interacts with ATM 2001 to transition to an appropriate display window. For example, if ATM 2001 were displaying first display container 201, beacon server 2004 may instruct ATM 2001 over communication channel 2053 to transition to second display container 202, where ATM 2001 displays a “Welcome” greeting and a PIN entry screen with the anticipation that mobile device 2003 is approaching ATM 2001. However, with some embodiment, if a different user successfully enters PIN information at ATM 2001 while the first user is approaching, ATM system 2000 may give priority to the different user.

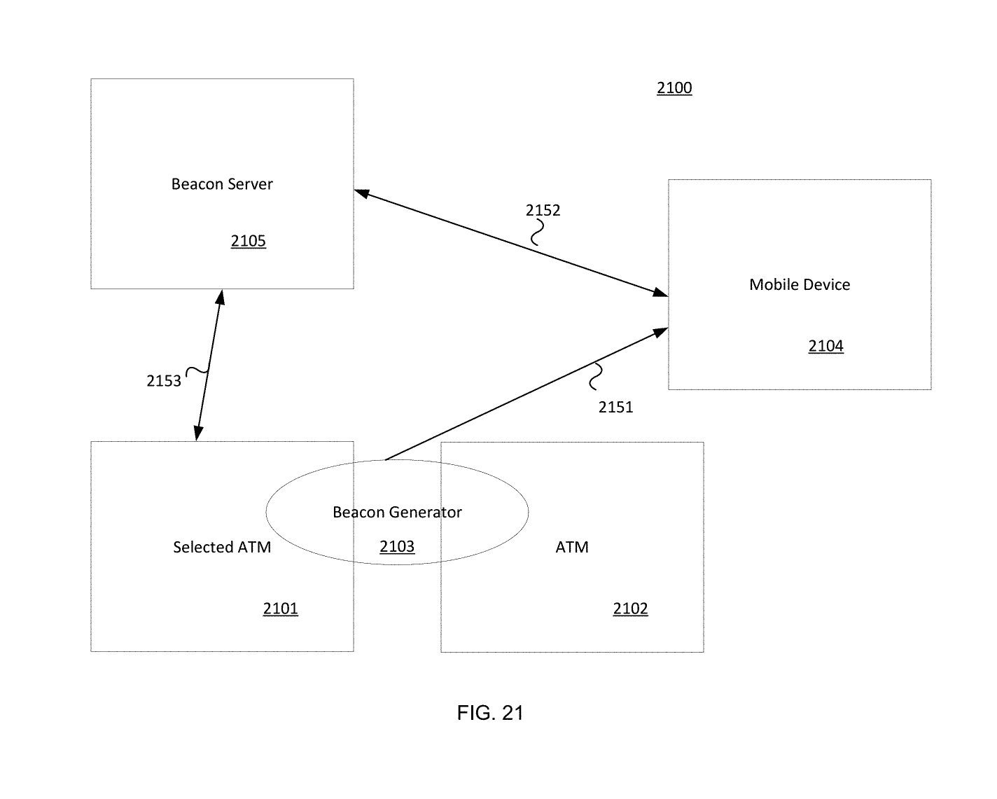

FIG. 21 shows a ATM system 2100 with beacon generator 2103 spanning a plurality of ATM's 2101 and 2102 in accordance with one or more illustrative aspects described herein. With, some embodiments, beacon generator 2103 may be in close proximity to ATM 2101 and/or ATM 2102 or may displaced from ATM's 2101 and 2102. With the latter situation, beacon generator 2103 may be situated at an entrance of a shopping mall while ATM 2101 and ATM 2102 may be situated in a cluster or at separate locations within the mall.

Similar to FIG. 20, beacon generator 2103 transmits beacon information over a wireless communication channel 2151 that may be received by wireless device 2104 via a mobile app when wireless device 2104 is within the range of beacon generator 2002 and as mobile device 2104 is approaching ATM 2101 and/or ATM 2102. The range of beacon 2103 may be larger than the range of beacon generator 2002 because system 2100 cover a larger service area than system 2000. As an example, communication channel 2151 may operate at class 1 (having an approximate range of 100 meters) while communication channel 2051 may operate at class 2 (having an approximate range of 10 meters) per the BLUETOOTH protocol.

Similar to FIG. 20, after mobile device 2104 extracts beacon information from wireless communication channel 2151, mobile device 2104 communicates with beacon server 2105 over wireless communication channel 2152 via the mobile app. With some embodiments, wireless communication channel 2152 is established to a website supporting ATM system 2100 via wireless service provided by a wireless service provider.

As will be further discussed, beacon server 2105 selects selected ATM 2101 from the plurality of associated ATM's 2101 and 2102. According to some embodiments, beacon server 2105 may select a selected ATM by different criteria. For example, beacon server 2105 may select an ATM that is closest to mobile device 2104 based on location information through the mobile app. Knowing the mobile device's location and the location of the ATM's, beacon server 2105 selects the ATM that is closest to mobile device 2104. As will be discussed, beacon server 2105 may also provide directions for a user of mobile device 2104 to selected ATM 2101. For example, beacon server 2105 may provide map content to ATM 2101 showing the way to ATM 2101 in a shopping mall when a user enters the shopping mall.

In response to communication between mobile device 2104 and beacon server 2105, beacon server 2105 interacts with selected ATM 2101 to transition to an appropriate display window. For example, if ATM 2101 were displaying first display container 201, beacon server 2105 may instruct ATM 2101 over communication channel 2153 to transition to second display container 202, where ATM 2101 displays a “Welcome” greeting and a PIN entry screen with the anticipation that the user is approaching ATM 2101.

When ATM 2102 is not available (for example, in use by someone else or out-of-service), beacon server 2105 may alternatively interact with ATM 2102 if it is available even if ATM 2102 were further away from mobile device 2104, than ATM 2101

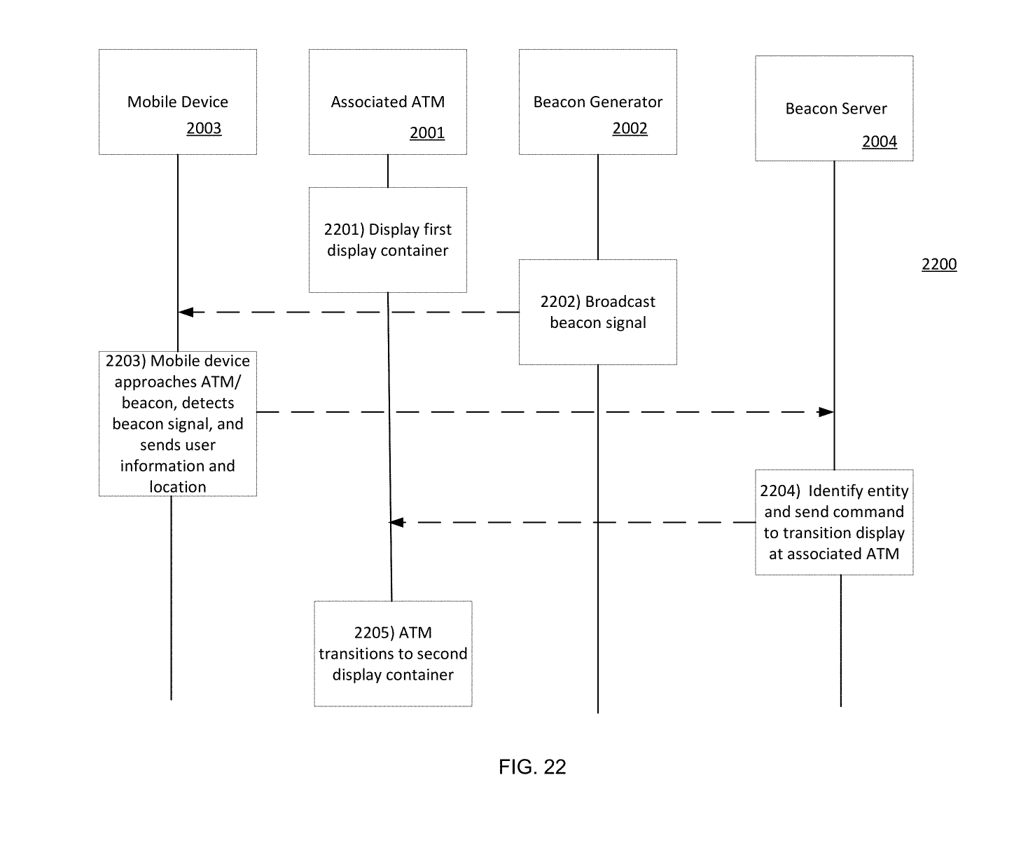

FIG. 22 shows illustrative event sequence 2200 for multicomputer processing with the computing environment shown in FIG. 20 in accordance with one or more example embodiments.

ATM 2001 displays a first display container (for example, container 301a as shown in FIG. 3) at block 2201. Beacon generator 2002 continuously broadcasts a beacon signal at block 2202, where the beacon signal conveys identification information about beacon generator 2002 and/or ATM 2001. Beacon generator 2002 may be physically situated at or within ATM 2001 or in close proximity to ATM 2001. However, with some embodiments, beacon generator 2002 may be displaced from ATM 2001. In such a situation, as will be discussed, a beacon server may provide directions (for example, map content) to a mobile device to guide the user to the designated ATM.

At block 2203, mobile device 2203 approaches ATM 2001/beacon generator 2002, detects the beacon signal (for example, signal 2051 as shown in FIG. 20), and sends user information and location information of mobile device 2003 via a mobile app to beacon server 2004.

Beacon server 2004 subsequently identifies the user (entity) and sends a command and/or content to ATM 2001 at block 2204 so that ATM 2001 transitions from the first display container to a second display container at block 2205 (for example, container 602 as shown in FIG. 6) so that the user may proceed with a transaction. Beacon server 2004 may use location information from mobile device 2003 to determine whether device 2003 is sufficiently close to ATM 2001 before ATM 2001 transitions display containers.

With some scenarios, ATM 2001 may not be available to handle the user of mobile device 2003 (for example, ATM 2001 may be handling another user or may be out of service). In such situations, beacon server 2004 may notify mobile device 2003 about the situation and may alert mobile device 2003 when ATM 2001 is available through, for example, a mobile app or via a text message.

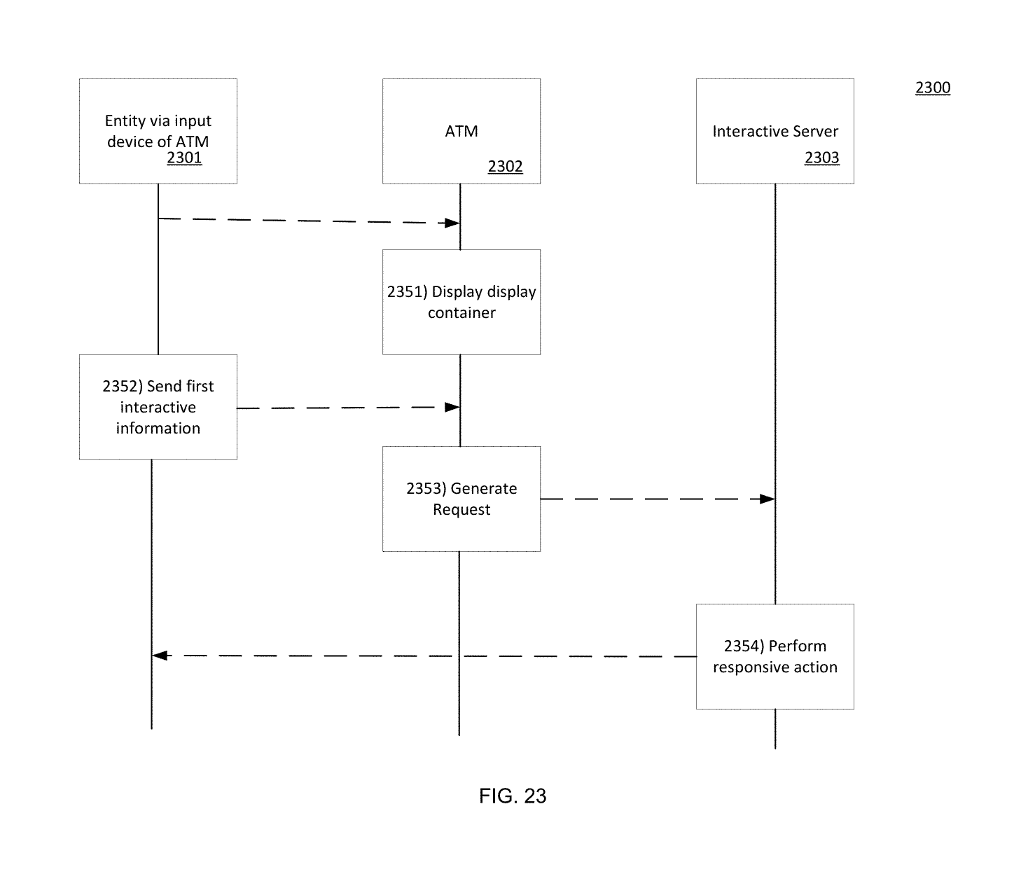

FIG. 23 shows illustrative event sequence 2300 for multicomputer processing with the computing environment shown in FIG. 20 in accordance with one or more example embodiments. When ATM 2302 is displaying a display container (for example, container 501a as shown in FIG. 5) at block 2351, an entity 2301 (user) may indicate a request for action directed to content shown in the non-transactional component by pressing a selected portion on the touchscreen of ATM 2302 (for example, selection 502 as shown in FIG. 5) at block 2352. If so, ATM 2302 sends the request for further action at block 2353 (corresponding to block 1611 as shown in FIG. 16). Based on the determined action, interactive server 2303 (which may be physically located on the same computing platform as beacon server 2004) performs a responsive action at block 2354. For example, interactive server 2303 may send further content information to entity 2301 via ATM 2302 (corresponding to action “Send more information” as shown in FIG. 16), schedule a meeting with a specialist (corresponding to action “Meet with a Specialist”), or generate an order for a service/item shown in the display container (corresponding to action “Fulfill Order”).

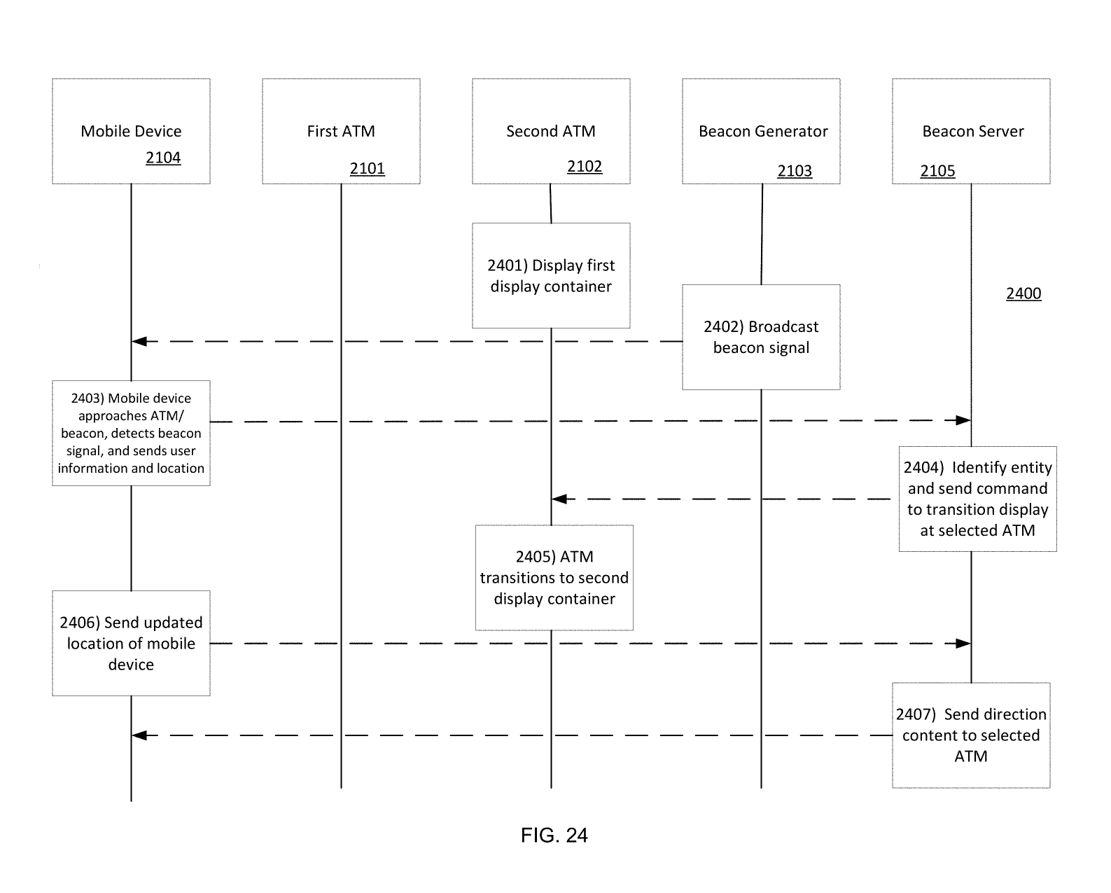

FIG. 24 shows illustrative event sequence 2400 for multicomputer processing with the computing environment shown in FIG. 21 in accordance with one or more example embodiments. Event sequence 2400 differs from event sequence 2200 in that beacon generator 2103 is associated with a plurality of ATM's (ATM 2101 and ATM 2102) where beacon server 2105 selects one of the plurality of ATM's based on a set of criteria as will be discussed.

Blocks 2401-2403 are similar to blocks 2201-2103 (as shown in FIG. 22), respectively. However, at block 2404 beacon server 2105 sends a command to ATM 2102 to transition display containers based on criteria (for example, distance between an ATM and the mobile device and/or the availability of an ATM) in order to enhance a user's experience. ATM 2102 transitions from a first display container to a second display container at block 2405.

With some embodiments, system 2100 may have a larger service footprint than system 2000 since system 2100 comprises a plurality of ATM's (for example, a cluster of ATM's or a collection of dispersed ATM's). System 2100 may be configured with beacon generator substantially separated from the associated ATMs (for example, at the entry of a shopping mall) while the associated ATM's are located at different points within the mall. Consequently, mobile device 2104 may send updated location information to beacon server 2105 at block 2406 so that server 2105 can send direction information (for example, map content) to device 2104 at block 2407.

With some embodiments, server 2105 may command ATM 2102 to transition display containers only when mobile device 2104 is sufficiently close to ATM 2102 based on location information provided by device 2104 at block 2406.

With some embodiments, mobile device 2104 may send its location information either once or more than once (so that the location can be updated as mobile device 2104 moves).

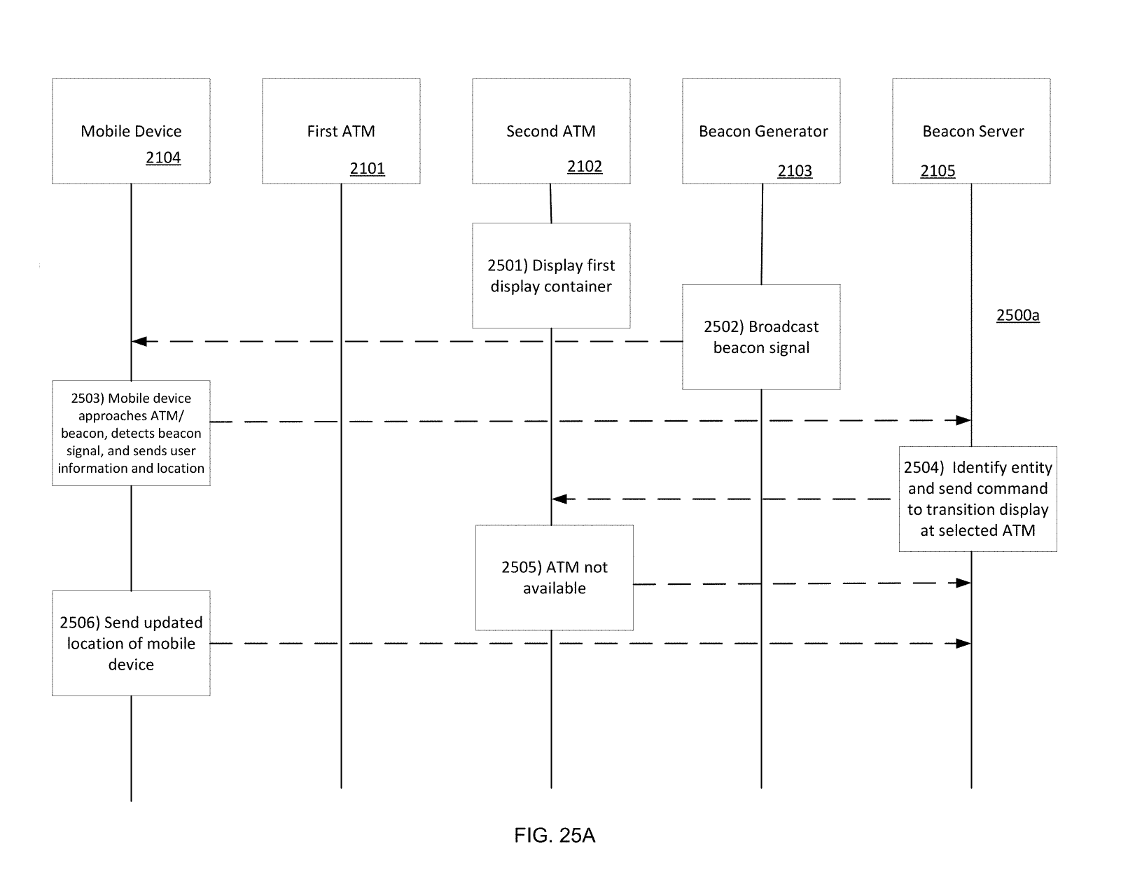

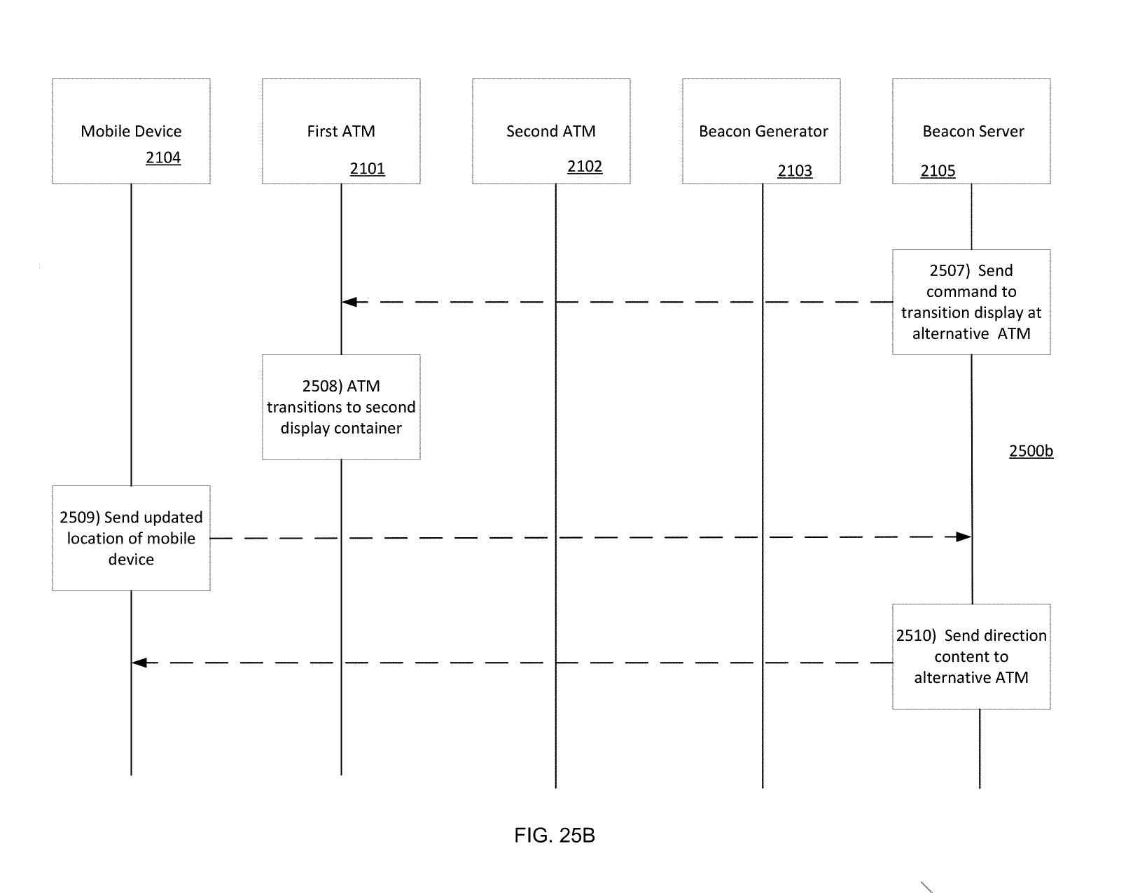

FIGS. 25A and 25B show illustrative event sequence 2500a and 2500b, respectively, for multicomputer processing with the computing environment shown in FIG. 21 in accordance with one or more example embodiments. As will be discussed, beacon server 2105 may select one of a plurality of ATM's, determine that the selected ATM is not available, and command an alternative ATM to handle the user of mobile device 2104. The plurality of ATM's may be configured as a cluster of ATM's in close proximity of each other or may be dispersed over the service area.

Referring to FIG. 25A, ATM displays a first display container at block 2501, beacon generator 2103 generates a beacon signal at block 2502, and mobile device 2104 approaches at block 2503, similar to the scenario shown in FIG. 24.

Beacon server 2105 subsequently selects ATM 2102 based on a set of criteria (for example, closest to mobile device 2104 or availability) and commands ATM 2102 to transition to a second display container at block 2504. However, ATM 2102 informs beacon server 2105 that it not available at block 2505. For the example, ATM 2102 may be already serving someone else or may be out-of-service.

Mobile device 2104 also sends its location information sometime daring event scenario 2500a (for example, at block 2506) and/or event scenario 2500b (for example, at block 2509).

Referring to FIG. 25B, which is a continuation of the scenario shown in FIG. 25, beacon server 2105 determines an alternative ATM (ATM 2101) based on the set of criteria at block 2507. For example, ATM 2101 may be the second closest. ATM for the plurality of ATM's.

Assuming that ATM 2101 is available, ATM 2101 transitions to a second display container at block 2508.

Based on location information sent by mobile device 2104 at blocks 2506 and/or 2509, beacon server 2105 sends direction information (for example, map content) to mobile device 2104 to guide the user to alternative ATM 2101.

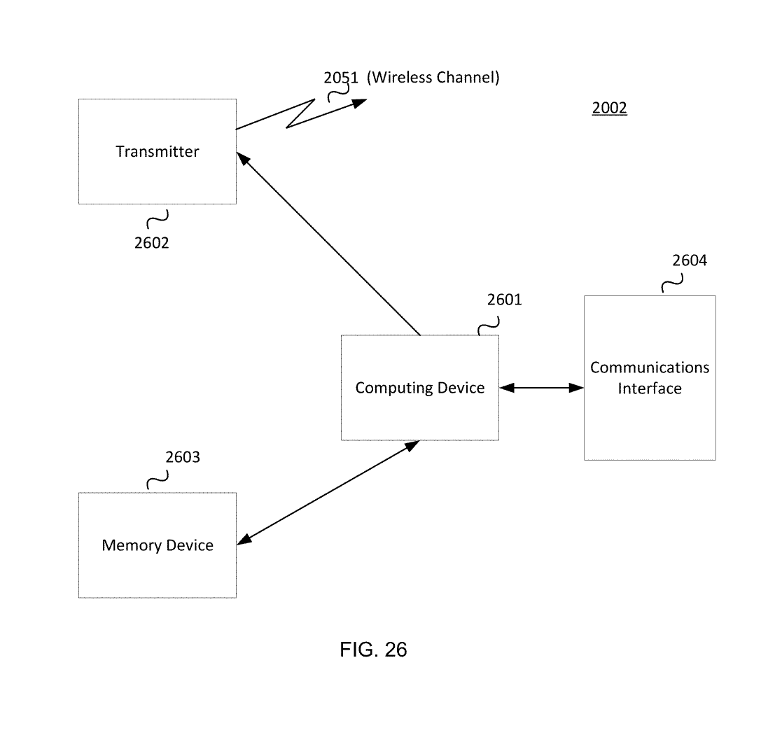

FIG. 26 shows beacon generator 2002 in accordance with one or more illustrative aspects described herein.

Beacon generator 2002 broadcasts a beacon signal over wireless channel 2051 by transmitter 2602. Computing device 2601, which executes computer-readable instructions from memory device 2603, instructs transmitter 2602 to include beacon information such as the beacon generator identification and/or associated ATM identification.

Beacon generator 2002 may be configured within ATM system 2000 or ATM system 2100 though communication interface 2604 so that the transmitted beacon information properly identifies beacon generator 2002 and/or associated ATM's.

The methods and features recited herein may further be implemented through any number of computer readable media that are able to store computer readable instructions. Examples of computer readable media that may be used include RAM, ROM, EEPROM, flash memory or other memory technology, CD-ROM, DVD, or other optical disc storage, magnetic cassettes, magnetic tape, magnetic storage and the like.

While illustrative systems and methods described herein embodying various aspects are shown, it will be understood by those skilled in the art that the invention is not limited to these embodiments. Modifications may be made by those skilled in the art, particularly in light of the foregoing teachings. For example, each of the elements of the aforementioned embodiments may be utilized alone or in combination or sub-combination with the elements in the other embodiments. It will also be appreciated and understood that modifications may be made without departing from the true spirit and scope of the present invention. The description is thus to be regarded as illustrative instead of restrictive on the present invention.

We claim:

1. A computer system comprising:
a first automated teller machine (ATM) displaying a first display container;
a beacon generator associated with the first ATM;
a support computing system;
the beacon generator transmitting a beacon signal over a wireless communication channel, the beacon signal containing beacon information identifying the beacon generator;
the support computing system receiving, from a first wireless device, a first subset of the beacon information, wherein the first subset identifies the beacon generator; and
the support computing system sending a first command to the first ATM to transition from the first display container to a second display container in accordance with the received first subset of the beacon information.

2. A computer system of claim 1, further comprising:
a second ATM displaying a current display container, wherein the beacon generator is also associated with the second ATM;
the computer system receiving, from a second wireless device, a second subset of the beacon information, wherein the second subset identifies the beacon generator;
the computer system selecting the second ATM when the first ATM is unavailable and the second ATM is available; and
the computer system sending a second command to the second ATM to transition to a different display container from the current display container.

3. A computer system of claim 1, further comprising:
the first ATM displaying a first display container during an un-authenticated session, wherein the first display container comprises non-transaction content;
the first ATM detecting whether an activation input has been entered, wherein the activation input is indicative that an entity requests transformation of the ATM to an ATM transaction;
the first ATM, in response to the detecting, displaying a second display container during an authenticated session, wherein the second display container comprises a first transaction display component and a first non-transaction display component;
the first ATM, in response to first input information during the authenticated session, displaying a third display container, wherein the third display container comprises a second transaction display component and a second non-transaction display component and wherein the second non-transaction display component is targeted to the entity; and
the first ATM displaying the first display container when the authenticated session has terminated.

4. A computer-assisted method for supporting a plurality of automated teller machines (ATM's), the method comprising:
displaying a first display container on a display of a first ATM during an un-authenticated session, wherein the first display container comprises non-transaction content;
detecting whether an activation input has been entered, wherein the activation input is indicative that a first entity requests transformation of the ATM to an ATM transaction;
in response to the detecting, displaying a second display container on the display of the first ATM during an authenticated session, wherein the second display container comprises a first transaction display component and a first non-transaction display component;
in response to first input information during the authenticated session, displaying a third display container on the display of the first ATM, wherein the third display container comprises a second transaction display component and a second non-transaction display component and wherein the second non-transaction display component is targeted to the first entity; and
when the authenticated session has terminated, displaying the first display container.

5. A computer-assisted method of claim 4, further comprising:
transmitting, by a beacon generator associated with the first ATM, a beacon signal over a wireless communication channel, wherein the beacon signal contains beacon information identifying the first ATM from the plurality of ATM's; and
receiving a command at the first ATM to transition to a designated display container.

6. A computer-assisted method of claim 5, further comprising:
receiving, by a support computing system from a mobile device, a subset of the beacon information, wherein the subset identifies the first ATM.

7. A computer-assisted method of claim 5, further comprising:
extracting, by the mobile device, the subset of the beacon information from the beacon signal; and
sending, by the mobile device, the subset of beacon information to the support computing system.

8. A computer-assisted method of claim 6, further comprising:
receiving, from the support computing system by the first ATM, a display command; and
transitioning, by the first ATM, from a current display container to a different display container.

9. A computer-assisted method of claim 8, wherein the different display container includes a personal identification number (PIN) screen.

10. A computer-assisted method of claim 9, further comprising:
receiving, by the support computing system from the mobile device, first identification information with the subset of beacon information, wherein the first identification information identifies the first entity;
in response to displaying the PIN screen, receiving, by the support computing system from the first ATM, first identification information, where the first identification information identifies the first entity; and
displaying a subsequent display container for the first entity during the authenticated session.

11. A computer-assisted method of claim 9, further comprising:
receiving, by the support computing system from the mobile device, first identification information with the subset of beacon information, wherein the first identification information identifies the first entity;
in response to displaying the PIN screen, receiving, by the support computing system from the first ATM, second identification information, where the second identification information identifies a second entity; and
displaying a subsequent display container for the second entity during the authenticated session, wherein the first entity and the second entity are different.

12. A computer-assisted method of claim 4, wherein at least one of the display containers comprises video content from a rear-view camera associated with the first ATM.

13. A computer-assisted method of claim 4, further comprising:
in response to displaying the third display container, receiving, by the first ATM, interactive information from the first entity; and
sending, by the first ATM to an interactive server, a request for responsive action.

14. A computer-assisted method of claim 4, further comprising:
sending, by the support computing system to a mobile device, direction information from a current location of the mobile device to the first ATM.

15. A computer-assisted method of claim 4, further comprising:
transmitting, by a beacon generator a beacon signal, wherein the beacon generator is associated with the plurality of ATM's, and wherein the beacon signal contains beacon information identifying the beacon generator.

16. A computer-assisted method of claim 15, further comprising:
receiving, by a support computing system from a mobile device, an information subset of the beacon information, wherein the information subset identifies the beacon generator;
selecting the second ATM from the plurality of ATM's based on the information subset; and
instructing the second ATM to transition from a current display container to a different display container.

17. A computer-assisted method of claim 16, wherein the selecting comprises:
determining, by the support computing system, that the first ATM is currently unavailable and that the second ATM is currently available.

18. A computer-assisted method of claim 16, wherein the selecting comprises:
determining, by the support computing system, that the second ATM is closer to the mobile device than the first ATM.

19. An apparatus comprising:
at least one processor for executing computer-executable instructions; and
at least one memory storing the computer-executable instructions that, when executed, cause the apparatus to perform a method comprising:
displaying a first display container on a display of an ATM during an un-authenticated session, wherein the first display container comprises non-transaction content;
detecting whether an activation input has been entered, wherein the activation input is indicative that an entity requests transformation of the ATM to an ATM transaction;
in response to the detecting, displaying a second display container on the display of the ATM during an authenticated session, wherein the second display container comprises a first transaction display component and a first non-transaction display component;
in response to first input information during the authenticated session, displaying a third display container on the display of the ATM, wherein the third display container comprises a second transaction display component and a second non-transaction display component and wherein the second non-transaction display component is targeted to the entity; and
when the authenticated session has terminated, displaying the first display container.

20. The apparatus of claim 19, wherein the at least one memory device stores additional computer-readable instructions that, when executed by the at least one processor, cause the apparatus to perform:
transmitting a beacon signal, wherein the beacon signal contains beacon information identifying the ATM;
receiving a display command; and
in response to the receiving the display command, transitioning from a current display container to a different display container on the display of the ATM.

21. A computer program product, comprising a computer usable, non-transitory medium having a computer readable program code embodied therein, said computer readable program code adapted to be executed by a processor to implement a method comprising:
displaying a first display container on a display of an ATM during an un-authenticated session, wherein the first display container comprises non-transaction content;
detecting whether an activation input has been entered, wherein the activation input is indicative that an entity requests transformation of the ATM to an ATM transaction;
in response to the detecting, displaying a second display container on the display of the ATM during an authenticated session, wherein the second display container comprises a first transaction display component and a first non-transaction display component;
in response to first input information during the authenticated session, displaying a third display container on the display of the ATM, wherein the third display container comprises a second transaction display component and a second non-transaction display component and wherein the second non-transaction display component is targeted to the entity; and
when the authenticated session has terminated, displaying the first display container.
